(19) United States
(12) Patent Application Publication
(10) Pub. No.: US 2026/0159176 A1
(43) Pub. Date: Jun. 11, 2026

(54) PANE FOR USE AS OUTER PROTECTIVE PANE OF A FUNCTION ROOF, USE THEREOF AND FUNCTION ROOFS

(71) Applicant: SCHOTT Technical Glass Solutions GmbH, Jena (DE)

(72) Inventors: Juliane Brandt-Slowik, Jena (DE); Hubert Wieseke, Jena (DE); Thilo Zachau, Jena (DE)

(73) Assignee: SCHOTT Technical Glass Solutions GmbH, Jena (DE)

(21) Appl. No.: 19/179,470

(22) Filed: Apr. 15, 2025

(30) Foreign Application Priority Data
Apr. 15, 2024 (DE) 10 2024 110 513.5

(51) Int. Cl. B62D 25/06; B32B 17/10; C03C 3/091; H02S 20/30

(52) U.S. Cl. CPC B62D 25/06; B32B 17/10036; B32B 17/10119; B32B 17/10449; B32B 17/10541; C03C 3/091; H02S 20/30; B32B 2307/202; B32B 2307/412; B32B 2307/558; B32B 2307/718; B32B 2307/7376; B32B 2457/12; C03C 2204/00

(57) ABSTRACT

A pane for use as an outer protective pane of a function roof includes glass. The pane has mechanical impact resistance and has a basis weight of not more than 2.45 kg/m². The pane, given a thickness of 5 mm, has transmittance exceeding 20% at every wavelength within at least one interval of at least 100 nm in a wavelength range between 3 μm and 12 μm.

### CROSS REFERENCE TO RELATED APPLICATIONS

This application claims priority to German Patent Application No. 10 2024 110 513.5 filed on Apr. 15, 2024, which is incorporated in its entirety herein by reference.

### BACKGROUND OF THE INVENTION

### 1. Field of the Invention

The present application relates to a pane for use as outer protective pane of a function roof, to use thereof, and to function roofs comprising said pane.

### 2. Description of the Related Art

Panes comprising glass or consisting of glass can be used in various applications, for example in vehicle panes, in architectural applications, or as covers for electronic devices.

For instance, EP3157774 A1 and WO19008471 A1, and also DE 20 2020 107 193 U1, describe panorama windscreens and laminated automobile roofs and panorama roofs. WO15059406 A1 describes a composite pane, especially as rear window or sunroof of a vehicle.

There is a growing trend for transparent glazing for buildings or vehicles to be transformed from mere windows to surfaces that fulfil further functions, for example shading, which are called switchable windows or privacy windows, or energy generation, for example solar windows. Such function units require sufficient protection.

Not only static applications, for example in the case of glazing of buildings and parts of buildings, but also mobile applications, for example in the automotive sector, require high robustness to a wide variety of different influences in order to protect the function units mentioned. Glass is advantageous here over plastics with its mechanical, thermal and chemical stability, its transmission properties and its radiation stability.

An important factor in respect of protection of the function units and of the space covered by the function roof is the mechanical strength of the function roof, i.e, the property of being subject to a minimum level of breakage, scratching or other damage under a wide variety of different forces. In the case of function roofs, especially in the case of those for mobile applications, mechanical resistance to impact, i.e. to falling hail or swirling sand or grit, for example, is of particular significance.

Temperature control is important for protection of the function units and the space covered by the function roof. For example, it should not become either too hot or too cold in the interior of a vehicle or building in spite of outside influences, irrespective of the function of the respective function unit.

These demands are not yet sufficiently satisfied by the protective panes from the prior art.

### SUMMARY OF THE INVENTION

Exemplary embodiments provided according to the present invention seek to provide a pane that satisfies the profile of requirements outlined for an outer protective pane. A further aspect is that of the use of said pane. A further aspect is that of provision of units comprising said pane.

In some embodiments provided according to the present invention, a pane for use as an outer protective pane of a function roof includes glass. The pane has mechanical impact resistance and has a basis weight of not more than 2.45 kg/m². The pane, given a thickness of 5 mm, has transmittance exceeding 20% at every wavelength within at least one interval of at least 100 nm in a wavelength range between 3 μm and 12 μm.

In some embodiments provided according to the present invention, a function roof, includes: an outer protective pane including glass, the outer protective pane having mechanical impact resistance and having a basis weight of not more than 2.45 kg/m², the outer protective pane, given a thickness of 5 mm, has transmittance exceeding 20% at every wavelength within at least one interval of at least 100 nm in a wavelength range between 3 μm and 12 μm; an inner pane; and a function unit including at least one function element.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows, as a box plot diagram for V1, A1 and A2, the results of haze measurements by gravel test Method A;

FIG. 2 shows, as a box plot diagram for V1, A1 and A2, the results of haze measurements by gravel test Method B; and

FIG. 3 shows, for V1 and A1, the results of haze measurements after the sandblasting test as well as the distribution of the measurement points on a pane.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The present invention relates to a pane for use as outer protective pane of a function roof, which comprises glass or consists of glass and has mechanical impact resistance and has a basis weight (d1) of not more than 2.45 kg/m², and wherein said pane, given a thickness of 4 mm, has transmittance exceeding 20% at every wavelength within at least one interval of at least 100 nm in the wavelength range between 3 μm and 12 μm.

An outer pane of a function roof means the pane in contact with the exterior in the unit, for example a building or a vehicle in which the function roof fulfils its function, as opposed, if appropriate, to the space enclosed by the unit, the interior. The pane which is “in contact” may be a coated or uncoated pane.

An inner pane of a function roof means the pane in contact with the interior in the unit, for example a building or a vehicle in which the function roof fulfils its function, the interior being the space enclosed by the unit, i.e., for example, the passenger cabin or part of a building, for example a room or conservatory.

The outer pane of a function roof is a protective pane since it protects the unit in which the function roof fulfils its function from outside influences.

The terms “function roof” or “function window” or “function glazing” are used synonymously in the present disclosure. In particular, the function roof also does not have to be disposed in the upper cover of the space, but may be positioned anywhere. It is optionally positioned in the upper cover of the space being enclosed.

The term “glass pane” is used in the present disclosure both for a pane comprising glass and for a pane consisting of glass.

What is meant by mechanical impact resistance in the present disclosure is as follows:

Resistance to stone-chipping and/or abrasion, e.g. sand abrasion, as shown by passing at least one of the following tests a) and b):

a) Gravel test, which can be used for simulation of stone-chipping:

This stone-chipping test by multi-impact testing according to DIN EN ISO 20567-1:2017-07[a], Methods A and B, is a standardized test method and serves, for example, to simulate stonechip damage on vehicles. The Erichsen 508 VDA test apparatus is used to bombard specimens with a rapid succession of sharp-edged impact bodies (e.g. standardized chilled iron grit). The influencing parameters can be varied in accordance with the standard specification. These include bombardment material, pressure, bombardment time and impact angle. For comparability of the multi-impact test, the parameters laid down in ISO 20567-1 are applicable. In the context of the present disclosure, the following materials and settings are used:
Bombardment time: 2×10 s±2 s
Bombardment material: hard iron grit according to DIN EN ISO 11124-2
Amount of grit: 2×500 g
Grit size: 3.55-5.00 mm according to DIN EN ISO 11125-2 and DIN EN ISO 565
Grit manufacturer: Eisenwerk Würth
Pressure: Method A: 1.0±0.1 bar; Method B: 2.0±0.1 bar
Impact angle: 54°
Test temperature: 24° C.±1° C.
Moisture content: 50%±4%
Pretreatment: at least 16 h at 23° C. and 50% relative humidity
Distance between grit acceleration tube and middle of sample: 290±1 mm

Stone-chipping resistance is found from the degree of damage. This can be compared with reference images and assigned to a corresponding index.

The degree of damage, however, also affects the haze of the pane. Haze is an optical parameter for the description of scattering characteristics and can be determined according to ASTM D1003, especially according to ASTM D1003: 2013. It is therefore also possible to use the determination of haze of the shot-blasted sample for a pass criterion in the gravel test.

The gravel test is considered to be passed when the sample that has undergone the outlined stone chip test by multi-impact testing according to DIN EN ISO 20567-1:2017-07[a] has a haze of not more than 4.0% by method A, i.e. after treatment with a pressure of 1 bar, or of not more than 8.0% by method B, i.e. after treatment with a pressure of 2 bar.

The haze thereof after treatment by method A is optionally only 3.0% at most, optionally only 2.5% at most.

The haze thereof after treatment by method B is optionally only 6.0% at most, optionally only 5.5% at most.

Each of the haze values in question is the average from five measurements on at least one tested pane, where the measurement points are chosen roughly in the middle of the sample and close to each of the four corners.

b) Sandblasting test, which can be used for simulation of abrasion by sand abrasion, for example:

The sand test according to MIL-STD-810H, Method 510.7, Procedure II, January 2019-01, is a standardized test method and serves, for example, to simulate sand abrasion damage on vehicles. This involves exposing the pane to a defined volume flow rate of sand. In the context of the present disclosure, the following materials and settings are used:
Temperature: 23° C.±2° C.
Relative humidity: <30%
Wind speed: 20 m/s
Sand concentration: (2.2±0.5) g/m³
Sand product designation: Quarzwerke WF31
Test side: 1
Test duration: 30 or 60 or 90 minutes per sample

The sandblasting test is considered passed when the sample that has undergone the outlined sand test according to MIL-STD-810H, Method 510.7, Procedure II, January 2019-01, has a haze of not more than 10% after treatment for 30 minutes or of not more than 15% after treatment for 60 minutes or of not more than 25% after treatment for 90 minutes.

The haze thereof after treatment for 30 minutes is optionally only 7% at most, optionally only 5% at most.

The haze thereof after treatment for 60 minutes is optionally only 12% at most, optionally only 10% at most.

The haze thereof after treatment for 90 minutes is optionally only 20% at most, optionally only 15% at most.

Each of the haze values in question is the average from five measurements on at least one tested pane, where the measurement points are chosen roughly in the middle of the sample and close to each of the four corners.

The pane has particularly high mechanical impact resistance if it passes both the gravel test and the sandblasting test.

Basis weight refers to the ratio of mass and area of a layer or sheet. The SI unit of basis weight is kg/m². The value is thus not normalized to a particular thickness, but is merely normalized to the area irrespective of thickness for one square metre of the respective article. This figure is standard for thin products such as paper or board. The figure for basis weight is thus used to compare products having very similar thicknesses.

Such a figure is not helpful in the case of panes, for example panes comprising glass or consisting of glass and having thicknesses that can vary over a wide range. Even within one field of application, for example automotive glazing, glasses having thicknesses of 0.5 mm to 7.5 mm are used.

Consequently, in this disclosure, a “basis weight (dx)” for a given thickness d=x mm of the pane is used.

The low basis weight as outlined, namely a basis weight (d1) of not more than 2.45 kg/m², is particularly significant for mobile applications, especially in the case of function roofs of mobile articles such as vehicles, since the energy expenditure needed for movement thereof is weight-dependent.

The low basis weight as outlined is also significant in the case of vehicles in that glass panes as a roof constituent, by comparison with lighter metal roofs, move the centre of gravity of the vehicle upward and hence worsen roadholding.

The low basis weight as outlined is particularly significant in the case of large function roofs, since the weight saving by comparison with higher basis weights is then particularly important.

The upper limit in the basis weight, for the same weight, enables greater thicknesses than in the case of glass panes having a higher basis weight, which means an advantageous increase in stability, or, for the same thickness, i.e. comparable stability, a lower weight, which is advantageous for the use and handling of the products, especially in the case of transport, installation and assembly.

These effects are particularly advantageous in the case of composites composed of two or more panes.

The pane optionally has a basis weight (d1) of less than 2.25 kg/m², optionally of not more than 2.23 kg/m², optionally of less than 2.23 kg/m².

The pane optionally has adequate chemical stability, in particular good hydrolytic stability and/or good acid stability.

Adequate chemical stability means that the DIN ISO 719/720 test for determination of hydrolytic stability and the DIN 12116:2001-03 test for determination of acid stability are each passed with at least class 2.

Good hydrolytic stability means that the DIN ISO 719/720 test for determination of hydrolytic stability is passed with at least class 1.

Good acid stability means that the DIN 12116:2001-03 test for determination of acid stability is passed with at least class 1.

Good chemical stability means that the DIN ISO 719/720 test for determination of hydrolytic stability and the DIN 12116:2001-03 test for determination of acid stability are each passed with at least class 1.

An important feature of the pane provided according to the invention is its transmission characteristics in the IR region. It has been found that, in the case of panes having transmittance exceeding 20% at every wavelength within at least one interval of at least 100 nm in the wavelength range between 3 μm and 12 μm, given a pane thickness of 4 mm, it is possible to avoid unwanted heating of the pane and of the function roof and hence also the function unit in the case of application.

The at least one interval within which transmittance of the pane exceeds 20% at every wavelength in the wavelength range between 3 μm and 12 μm, given a pane thickness of 4 mm, is optionally at least 145 nm.

The at least one interval within which transmittance of the pane exceeds 20% at every wavelength in the wavelength range between 3 μm and 12 μm, given a pane thickness of 4 mm, is optionally at least 170 nm.

The at least one interval within which transmittance of the pane exceeds 20% at every wavelength in the wavelength range between 3 μm and 12 μm, given a pane thickness of 4 mm, is optionally at least 200 nm.

If the case of application is such that the pane, for the functioning of the function unit, is to transmit only little IR light, if any, this is specifically not achieved by absorption, which would mean heating, but rather by means of an IR-reflecting film or coating of the pane, for example a metallic silver layer.

Some exemplary thicknesses of the glass pane are at least 0.5 mm and at most 7.5 mm; some exemplary thicknesses are at least 1 mm and at most 4 mm; some exemplary thicknesses are at least 1.75 mm and at most 3.8 mm; some exemplary thicknesses are at least 1.8 mm and at most 3 mm.

Glass panes having thicknesses of 0.5 mm to 4 mm are optionally used in mobile applications.

Glass panes having thicknesses of 3 mm to 7.5 mm are optionally used in static applications.

Some exemplary formats of the glass pane are between 1500 mm×800 mm and 4500 mm×2500 mm. Some exemplary formats are 2500 mm×1500 mm to 3000 mm×2500 mm, and for particular applications, for example panorama roofs, even at least or more than 3000×2500 mm².

For static applications, especially for glazing of buildings, some exemplary formats are 3700×2300 mm² to 4200×2450 mm² or to 4000×2450 mm².

The glass pane provided according to the invention can be implemented by various glass types, for example by alkali metal-free alumino (boro) silicate glasses, called AF glasses, by (lithium) alumino (boro) silicate glasses, called LA (B) S glasses, or by borosilicate glasses.

It may be advantageous and particularly easy to achieve the profile of properties of the pane provided according to the invention, especially with regard to the desired low weight, but also the mechanical strength and transmission properties of the glass pane, when the pane comprises a borosilicate glass or consists of borosilicate glass.

The borosilicate glass optionally comprises the following components in % by weight based on oxide:
SiO₂ 70-87
B₂O₃ 7-25
Na₂O+K₂O 0.5-9
Al₂O₃ 0-7
CaO 0-3
MgO 0-2
   or
SiO₂ 70-86
Al₂O₃ 0-5
B₂O₃ 9.0-25
Na₂O 0.5-5.0
K₂O 0-1.0
Li₂O 0-1.0
   or
SiO₂ 78.3-81.0
B₂O₃ 9.0-13.0
Al₂O₃ 3.5-5.3
Na₂O 3.5-6.5
K₂O 0-2.0
CaO 0-2.0

With such borosilicate glass compositions, it is possible to achieve the glass panes suitable in accordance with the invention for use as outer protective pane of a function roof that have high mechanical impact resistance, low basis weight and high IR transmittance.

It is also easily possible in this way to obtain glasses having only a low coefficient of thermal expansion.

To wit, the glass pane optionally has a coefficient of expansion CTE20-300 between 2.5×10⁻⁶/K and 5.5×10⁻⁶/K, optionally between 2.7×10⁻⁶/K and 5.2×10⁻⁶/K, optionally between 3.0×10⁻⁶/K and 5.0×10⁻⁶/K, optionally of (3.3±0.1)×10⁻⁶/K.

With such a coefficient of expansion, the pane is suitable for coating with coatings as desired, for example, for the inside of the outer pane of automotive glazing.

With such borosilicate glass compositions, it is possible to provide a material which, on the basis of its dielectric constant and its loss angle at frequencies >10 GHz, is suitable for protection of the antenna structures, for example, in an antenna system integrated into a sunroof, an aspect that is becoming ever more important owing to desired communication systems between vehicles and satellites. Such a material is transparent to 5G/6G signals, which makes its incorporation into the vehicle shell particularly attractive.

The glass pane provided according to the invention may be used as a self-supporting pane. Especially when the glass pane provided according to the invention is not used as a self-supporting pane but in a laminate, it may be combined with various materials, for example laminated with a soda-lime silicate glass, an aluminium silicate glass, an alkali metal aluminosilicate glass, an alkali metal borosilicate glass, an alkali metal aluminophosphosilicate glass, an alkali metal aluminoborosilicate glass or combinations thereof, combined with a polymer film, e.g. PVB, EVA or TPU.

The laminate may be formed from identical glasses or from different glasses, but with mutually matched coefficients of expansion, or from glass and plastic panes having mutually matched coefficients of expansion.

In some embodiments, the glass pane has transmittance Y (D65, 2°) of at least 91%, optionally of at least 92.5% or even of at least 93%. This minimum value is optionally based on a glass pane having a thickness of 5 mm.

High transmittance ensures to a particular degree that the glass pane in applications designed for transparency enables an excellent and undistorted view through it.

High transmittance is particularly important for energy-generating windows in which the outer glass panes serve as waveguide in the direction of the high-efficiency solar cells surrounding such panels. Every increase in transmission has a direct effect on the generation of energy.

The terms “transmittance” and “brightness” Y correspond to the same measurement parameter, measured according to DIN 5033 in the CIE colour system as Y (D65, 2°).

In some embodiments, the glass pane has transmittance Y (D65, 2°) of at most 60%, optionally of at most 50%. This minimum value is optionally based on a glass pane having a thickness of 5 mm. This low transmittance in the visible is optionally achieved by addition of coloured oxides, for example of iron oxide and/or cerium oxide and/or nickel oxide and/or cobalt oxide and/or titanium oxide and/or vanadium oxide and/or manganese oxide and/or copper oxide and/or tin oxide and/or molybdenum oxide and/or chromium oxide, optionally in a total proportion of not more than 5% by weight.

The shading achieved by such low transparency may be attractive particularly in applications such as panorama roofs or aesthetic roofs.

Preference may be given to embodiments in which shading or darkening, especially in the case of a highly transparent pane, i.e. a pane having transmittance Y (D65, 2°) of at least 91%, optionally of at least 92.5% or even of at least 93%, is achieved by a switchably activatable shadowing or darkening film or interlayer in the composite, as is the case in many smart window applications, for example in switchable window or privacy window applications, having electrochromic layers or liquid-crystal units for example.

The technical term “smart windows” means windows having glazing that can change its properties according to the users' requirements. For instance, it is possible to reversibly adjust transparency, translucence, color and reflectance depending on environmental conditions, for example direct insolation. Many of these usually switchable and controllable glazing systems are based on the use of liquid crystals in the pane interspace, i.e. in the space formed by the pane composite.

Energy-recovering windows use insolation for power generation. Switchable windows offer solar protection and help to lower energy costs and CO₂ emissions.

Privacy windows that switch immediately from transparent to translucent can replace blinds and ensure privacy.

Shading and thermally insulating devices are optionally implemented by electrochromic systems or suspended particle devices. They switch from transparent to dark in use, i.e. keep the sun outside the interior of the building and help to lower energy costs. By contrast, liquid-crystal solutions are used more as privacy windows. They switch from translucent to white-opaque.

High transmittance in accordance with the invention in the IR region assists achievement of high-efficiency in glazing with energy-generating windows. Particularly in systems in which the glass pane as waveguide directs the photons to the outside solar cells, an increase in energy yield is possible.

The pane in embodiments suitable for use as outer protective pane of a function roof can be used in a function roof for mobile applications, especially for vehicles, optionally for land vehicles, especially road vehicles such as optionally trucks or cars, irrespective of drive type, optionally with electrical or hybrid drive, or for rail vehicles such as optionally railway or tram carriages.

The pane in embodiments suitable for use as outer protective pane of a function roof can also be used in a function roof for static applications, especially for glazing of greenhouses and buildings, in particular fire protection glazing, or for conservatories for example. It may be preferable, especially in fire protection glazing, to use the pane as outer protective pane for vertical or horizontal energy-generating glazing.

Advantageously, the glass pane provided according to the invention can be manufactured in a method of manufacturing a glass pane, especially a method of continuously manufacturing a glass pane, comprising the steps of
providing a batch comprising glass raw materials,
melting the batch to obtain a glass melt,
adjusting the viscosity of the glass melt,
transferring the glass melt to an apparatus for hot forming, especially by drawing, optionally floating,
hot forming the glass, especially drawing, optionally floating, to form a glass strip
singularizing the hot-formed glass strip to obtain a glass pane.

The method used for production of the glass pane provided according to the invention is the float method by way of example, but manufacture is not limited to such a method. Manufacture can be implemented, without limiting generality, for example, by a drawing process, in particular a float process or a down-draw process, for example an overflow fusion or a drawing nozzle process.

The details of the drawing methods and of the plants for drawing methods, and also of the float method and the plants for float methods, are known to the person skilled in the art. Optionally, the glass pane in some embodiments takes the form of a float glass pane.

The glass strip, especially in the float process, after the hot shaping and prior to singularization, is optionally subjected to a cooling step in which its temperature is in the range between Tg+20 K and Tg−20 K over a period of at least 30 s. Tg is the transformation temperature of the glass. Specifically in a float process where the glass strip is lifted off the metal melt and transported onward into a cooling lehr via a dross box, the temperatures of the glass strip in the dross box and at the start of the cooling lehr optionally differ by not more than 10 K.

The pane produced by the process mentioned for production of a glass pane, especially a process for continuous production of a glass pane, optionally has a temperature at the viscosity of 10^{7.6} dPas of less than 1000° C., optionally of less than 850° C.

This means that it has sufficiently good 3D formability for use thereof as outer protective pane of a function roof in many embodiments.

For example, function roofs for cars are 3D-shaped. In the case of function roofs for cars-unlike the case of normal photovoltaic (PV) roofs and their cover panes, for example—modular exchange is impossible in the event of fracture owing to the 3D shape thereof. High mechanical durability of the pane is thus particularly important here. 3D formability thereof is thus an important additional property since, in the applications where it is relevant, mechanical impact resistance, one of its properties essential to the invention, is particularly valuable.

The step of 3D forming of the pane is typically effected after it has been cut to size, its edges have been processed and it has optionally been printed.

In some embodiments, for example for safety glazing, it may be of interest to subject the glass pane provided according to the invention to the known process of chemical or thermal tempering. The person skilled in the art knows how to select the appropriate parameters for such processes. For example, they know how to adapt the tempering processes with regard to the different thicknesses, especially to adjust the temperature-time profile in thermal tempering. For instance, a much narrower process window exists for lower thicknesses.

However, the figures for properties that are given in the disclosure, especially also those for mechanical impact resistance, do not relate to tempered glass panes.

The wording “the pane consists of glass” means the material of the pane and does not say anything about any coatings of the pane. Both the pane comprising glass and the pane consisting of glass may thus have one or more fully or partly applied coatings. Such coatings may be, for example:
UV-blocking and/or -reflecting layers, for example comprising or consisting of titanium oxide and/or silicon oxide and/or aluminum oxide and/or tin oxide and/or amorphous carbon, e.g. DLC (diamond-like carbon)
IR-blocking and/or -reflecting layers, e.g. metallic silver layers
enamel layers
anti-scratch coatings, for example comprising or consisting of titanium oxide and/or silicon oxide and/or amorphous carbon, e.g. DLC (diamond-like carbon)
transparent conductive coatings, for example comprising or consisting of indium tin oxide (ITO) and/or fluorine-doped tin oxide (FTO) and/or transparent zinc oxide (TZO). The conductive coatings may cover the full area or be structured.

### Examples

Table 1 reports various properties for example panes in two working examples (identifier beginning with A) and one comparative example (identifier beginning with V). Working example A1 is a borosilicate glass 3.3, i.e. a borosilicate glass having a coefficient of expansion CTE20-300 of 3.3×10⁻⁶/K. Working example A2 is a borosilicate glass 4.0, i.e. a borosilicate glass having a coefficient of expansion CTE20-300 of 4.0×10⁻⁶/K. Comparative example V1 is a soda-lime glass.

The glasses were produced by the float process.

The working examples were produced by drawing at such a drawing rate that they had a temperature between Tg+20 K and Tg−20 K in the dross box and cooling lehr for at least 30 s.

The panes were reduced to customary sample dimensions. The following properties were determined thereon, as listed in Table 1:
thickness of the pane;
transformation temperature Tg [° C.];
transmittance Y (D65, 2) in %, measured to DIN 5033 in the CIE colour system on a sample of the respective example having a thickness of 5 mm;
width [nm] of the interval within the wavelength range between 3 μm and 12 μm in which transmittance in a sample having a thickness of 5 mm from the respective example is above 20% at every wavelength (“IR-d”);
basis weight for thickness 1 mm (“d1”) in kg/mm×m², with determination of the respective basis weight using a pane of the thickness given in the table and conversion of the results to the relevant thickness of 1 mm;
“starting haze”, i.e. haze prior to performance of the stress test, determined to ASTM D1003: 2013,
haze, determined to ASTM D1003: 2013, after performance of the sandblasting test; performed with the following materials and settings:
   Temperature: 23° C.±2° C.
   Relative humidity: <30%
   Wind speed: 20 m/s
   Sand concentration: (2.2±0.5) g/m³
   Sand product designation: Quarzwerke WF31
   Test side: 1
   Test duration: for each sample, 30 (group A) or 60 (group B) or 90 (group C) minutes
haze, determined to ASTM D1003: 2013, after performance of the gravel test according to DIN EN ISO 20567-1:2017-07[a]; performed with the following materials and settings:
   Bombardment time: 2×10 s±2 s
   Bombardment material: hard iron grit according to DIN EN ISO 11124-2
   Amount of grit: 2×500 g
   Grit size: 3.55-5.00 mm according to DIN EN ISO 11125-2 and DIN EN ISO 565
   Grit manufacturer: Eisenwerk Würth
   Pressure: Method A: 1.0±0.1 bar; Method B: 2.0±0.1 bar
   Impact angle: 54°
   Test temperature: 24° C.±1° C.
   Humidity: 50%±4%
   Pretreatment: at least 16 h at 23° C. and 50% relative humidity
   Distance between grit acceleration tube and middle of sample: 290±1 mm

TABLE 1

| | A1 | A2 | V1 |
|---|---|---|---|
| d [mm] | 3.8 | 3.8 | 4.0 |
| | (for sandblasting test: | (for sandblasting test: | (for sandblasting test: |
| | 7.5; for Y and IR-d: | 8; for Y and IR-d: 5) | 8; for Y and IR-d: 5) |
| | 5) | | |
| Tg [° C.] | 530 | 590 | 540 |
| Y (D65, 2°) [%] | 93.1 | 92.9 | 91.0 |
| IR-d [nm] | 220 | 175 | 0 |
| d1 [kg/mm × m²] | 2.2 | 2.35 | 2.5 |
| Starting haze [%] | 0.1 | 0.2 | 0.2 |
| Haze [%] after | 4.2 | 4.8 | 11.5 |
| sandblasting test, | | | |
| 30 min | | | |
| Haze [%] after | 9.2 | 9.7 | 19.4 |
| sandblasting test, | | | |
| 60 min | | | |
| Haze [%] after | 13.7 | 16.0 | 30.3 |
| sandblasting test, | | | |
| 90 min | | | |
| Haze [%] after gravel | 2.1 | 2.1 | 5.6 |
| test, Method A | | | |
| Haze [%] after gravel | 4.3 | 4.7 | 12.7 |
| test, Method B | | | |

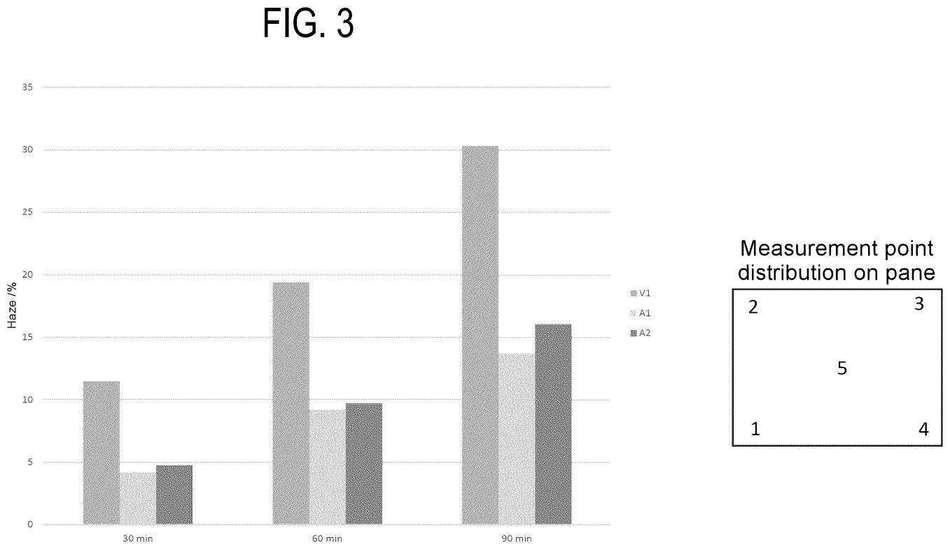

Each of the haze values reported for the sandblasting test is the average from five measurements on one tested pane, where the measurement points, according to the diagram in FIG. 3, were chosen roughly in the middle of the sample and close to each of the four corners.

Each of the haze values reported for the gravel test is the average from the number of tested panes, with performance of five measurements per pane tested, where the measurement points were chosen roughly in the middle of the sample and close to each of the four corners. For V1, one pane was tested in Method A, two panes in Method B. For A1 and A2, two panes in each case were tested in Method A, and four panes in each case in Method B.

With haze values below 10 or below 15 or below 25 (sandblasting test for 30, 60, 90 min) and below 4 (gravel test at 1 bar) or below 8 (gravel test at 2 bar), the working examples passed both tests and have the requisite stone chip resistance and abrasion resistance, and hence also the mechanical impact resistance that is essential to the invention.

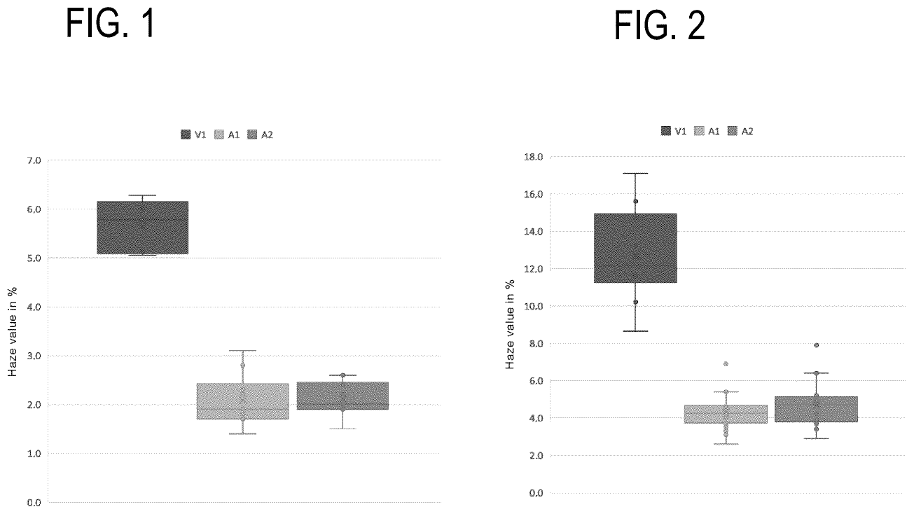

The graph of the haze values can be found in FIGS. 1 to 3.

FIG. 1 shows, as a box plot diagram for V1, A1 and A2, the results of the haze measurements by gravel test Method A.

FIG. 2 shows, as a box plot diagram for V1, A1 and A2, the results of the haze measurements by gravel test Method B.

FIG. 3 shows, for V1 and A1, the results of the haze measurements after the sandblasting test. FIG. 3 also shows the distribution of the measurement points on a pane.

A further possible measure for stone chip resistance determined according to DIN EN ISO 20567-1:2017-07 was the degree of damage after performance of the gravel test by assessment of the damage area. This involved determining what is called a characteristic value which is assigned in each case to a particular proportion [%] of the damaged area.

TABLE 2

| | V1 | V1 | A1 | A1 | A2 | A2 |
|---|---|---|---|---|---|---|
| | Char. | Damaged | Char. | Damaged | Char. | Damaged |
| Method | value | area [%] | value | area [%] | value | area [%] |
| A | 2.5 | 10.7 | 1.0 | 1 | 1.0 | 1 |
| (1 bar) | | | | | | |
| B | 3.0 | 19.2 | 2.0 | 5.5 | 2.0 | 5.5 |
| (2 bar) | | | | | | |

It can also be seen from these values that the stone chip resistance of the working examples is much higher than that of the comparative example.

The pane is suitable for use as outer protective pane of function glazing and is optionally indeed used for that purpose.

Preference may be given to use as outer protective pane of a thermal roof or of a panorama roof or of an aesthetic roof or of a switchable window or of a solar roof.

The invention also provides function glazing, i.e. a function roof, having an outer protective pane provided according to the disclosure. As well as the outer protective pane, this has an inner pane, optionally further panes, and a function unit comprising at least one function element, especially a function layer. Function layers may take the form of a coating or of a film.

Examples of function layers include:
transparent conductive coatings, for example comprising or consisting of indium tin oxide (ITO) and/or fluorine-doped tin oxide (FTO) and/or transparent zinc oxide (TZO), which may cover the full area or else be structured
grey wedges
polymer films having vibration-damping function switchable films
energy-converting layers

The invention also provides a function roof in the form of a thermal roof.

A thermal roof in this disclosure means the following:
a function glazing that converts radiation, optionally IR radiation, to a lower-wavelength radiation, optionally light energy, and draws the energy needed for the purpose from a heat reservoir, optionally interiors of buildings or vehicles.

It is a particular feature of the thermal roof provided according to the invention that it includes a function unit having a function element, especially a function layer, capable of converting IR radiation, i.e. thermal energy, to light energy. This thermal energy comes from the space enclosed by the outer protective pane and further delimitations, especially panes or walls. The space from which the heat is drawn, usually the interior of the unit, i.e. of the vehicle or building or part of the building in particular, is thus cooled.

The outer protective pane in the thermal roof has a thickness of at least 0.5 mm to at most 7.5 mm, optionally at least 1 mm and at most 4 mm, optionally 1.75 mm to 3 mm.

The function layer or the layer package of what is called a down-conversion cooling may take the form of a film and be stuck on. It may also be applied directly to the conductive coating, which may be structured.

The invention also provides a function roof in the form of a panorama roof.

A panorama roof in this disclosure means a glass surface in a vehicle that combines windscreen and sunroof.

It is a feature of the panorama roof provided according to the invention that the outer protective pane has a length of at least 1200 mm, optionally at least 3000 mm, and at most 4500 mm, a width of at least 1200 mm, optionally at least 2500 mm, and at most 3000 mm, and a thickness of 0.5 mm to 7.5 mm, optionally up to 4 mm, optionally up to 3.8 mm. An exemplary format is an area of at least 3000×2500 mm².

The panorama roof, similarly to a windscreen, has what is called a grey wedge. A grey wedge is a tinted anti-dazzle strip. It may take the form of an electrical blind having electrically switchable transparency. In spite of its name, rather than a grey shade, it may also have other shades, for example a blue or green shade. In the case of a pure windscreen, this is present at the upper edge thereof. In the case of a panorama roof, it is in the sunroof region and extends into the upper region of the windscreen region. It is integrated into the multilayer, optionally two-layer, composite in the form of a function unit. It serves to reduce insolation and the associated heating of the vehicle. In so doing, it does not impair the field of view.

In order to shield the passenger cabin from bothersome outside noise, sound-deadening mats are used in vehicles with metal roofs. This is not possible in the case of glazing since the transparent function of the glazing is otherwise lost. It is necessary here to make use of special polymer films as function interlayer. Therefore, the panorama roof has a polymer film having vibration-damping function as a function interlayer. This is intended to damp vibrations that occur between 50 Hz and 20 kHz.

The invention also provides a function roof in the form of an aesthetic roof.

An aesthetic roof in this disclosure means the following: function glazing containing a function unit in which various function elements are intended to achieve a visual impression in their usually artistic form, for example points of light, patterns, dark spots, switchable modules.

It is a feature of the aesthetic roof provided according to the invention that the outer glass pane thereof has transmittance Y (D65, 2°) of at least 92.5%, optionally of at least 93%, based on a glass pane having a thickness of 5 mm, and that the function unit thereof has light-emitting devices as function element. These are optionally integrated into the multilayer, optionally two-layer, composite in the form of a function unit. The light-emitting devices thereof generate a decorative and/or functional illumination. One example of light-emitting devices is organic light-emitting diodes, called OLEDs.

Such an aesthetic roof may, for example, be integrated into vehicles, i.e. in a mobile application, or into buildings, i.e. in a static application. The preferred formats depend on the type of application. For static applications, especially for glazing of buildings, exemplary formats are 3700×2300 mm² to 4200×2450 mm² or to 4000×2450 mm², and/or thicknesses of 2 mm to 7.5 mm.

The invention also provides a function roof in the form of a switchable window. A switchable window here means a function roof in which the function of the function unit can be electrically switched on and off, where electrical energy is supplied by a transparent conductive coating included in or applied to the outer protective pane.

Particular functions of the switchable window are that the function element disposed between the outer protective pane and inner pane in the function unit of the switchable window is a switchable film and that a transparent conductive coating has been applied on the side of the outer protective pane facing the film and that the outer protective pane has transmittance Y (D65, 2°) of at least 92.5%, optionally of at least 93%, based on a glass pane having a thickness of 5 mm.

The invention also provides a function roof in the form of a solar roof.

A solar roof in this disclosure means function roofs having function units capable of converting solar energy to electrical energy.

It is a feature of the solar roof provided according to the invention that the function unit includes, as function element, an electrical component that converts radiative energy, optionally UV and/or VIS and/or IR radiation directly to electrical energy, and that the outer protective pane has transmittance Y (D65, 2°) of at least 92.5%, optionally of at least 93%, based on a glass pane having a thickness of 5 mm.

The solar roof may be implemented in various ways: for example by the presence of the solar cell directly beneath the outer protective pane without contact therewith, where the glass pane assumes its protective function. This does not require contact between solar cell and protective pane. Or in that the outer protective pane has a transparent conductive coating and, as well as protective function, also assumes the function of output conduction.

A common factor in all these function roofs is that the property of the outer protective pane that its transmittance exceeds 20% at every wavelength within at least one interval of at least 100 nm in the wavelength range between 3 μm and 12 μm, given a pane thickness of 4 mm, is of particular significance since it is thus possible to avoid unwanted heating of the pane and of the function roof and hence also the function unit in the case of application.

A common factor in all these function roofs is that mechanical impact resistance of the outer protective pane is of particular significance since it is exposed to the risk of high impact loads in application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A pane for use as an outer protective pane of a function roof, the pane comprising glass, the pane having mechanical impact resistance and having a basis weight of not more than 2.45 kg/m², wherein the pane, given a thickness of 5 mm, has transmittance exceeding 20% at every wavelength within at least one interval of at least 100 nm in a wavelength range between 3 μm and 12 μm.

2. The pane of claim 1, wherein the pane has at least one of the following:
a coefficient of expansion CTE20-300 of between 2.5×10⁻⁶/K and 5.2×10⁻⁶/K;
adequate chemical stability; or
the basis weight is less than 2.23 kg/m².

3. The pane of claim 1, wherein, given a pane thickness of 5 mm, the transmittance, in the wavelength range between 3 μm and 12 μm, exceeds 20% at every wavelength in at least one interval of 145 nm.

4. The pane of claim 3, wherein, given a pane thickness of 5 mm, the transmittance, in the wavelength range between 3 μm and 12 μm, exceeds 20% at every wavelength in at least one interval of 170 nm.

5. The pane of claim 1, wherein the glass is borosilicate glass.

6. The pane of claim 5, wherein the borosilicate glass comprises, in % by weight based on oxide:
SiO₂ 70-87;
B₂O₃ 7-25;
Na₂O+K₂O 0.5-9;
Al₂O₃ 0-7;
CaO 0-3; and
MgO 0-2.

7. The pane of claim 5, wherein the borosilicate glass comprises, in % by weight based on oxide:
SiO₂ 70-86;
Al₂O₃ 0-5;
B₂O₃ 9.0-25;
Na₂O 0.5-5.0;
K₂O 0-1.0; and
Li₂O 0-1.0.

8. The pane of claim 5, wherein the borosilicate glass comprises, in % by weight based on oxide:
SiO₂ 78.3-81.0;
B₂O₃ 9.0-13.0;
Al₂O₃ 3.5-5.3;
Na₂O 3.5-6.5;
K₂O 0-2.0; and
CaO 0-2.0.

9. The pane of claim 1, wherein the pane has a thickness of 0.5 mm to 7.5 mm.

10. The pane of claim 9, wherein the thickness of the pane is 1.75 mm to 3.8 mm.

11. A function roof, comprising:
an outer protective pane comprising glass, the outer protective pane having mechanical impact resistance and having a basis weight of not more than 2.45 kg/m², wherein the outer protective pane, given a thickness of 5 mm, has transmittance exceeding 20% at every wavelength within at least one interval of at least 100 nm in a wavelength range between 3 μm and 12 μm;
an inner pane; and
a function unit comprising at least one function element.

12. The function roof of claim 11, further comprising one or more further panes.

13. The function roof of claim 11, wherein the function roof is in the form of a thermal roof, the function unit containing a function layer capable of converting infrared radiation in the form of thermal energy to light energy, where the thermal energy comes from a space enclosed by the outer protective pane and further boundaries, and the outer protective pane has a thickness of at least 0.5 mm to at most 7.5 mm.

14. The function roof of claim 13, wherein the thickness of the outer protective pane is at least 1 mm and at most 4 mm.

15. The function roof of claim 11, wherein the function roof is in the form of a panorama roof, the outer protective pane having a length of at least 1200 mm, a width of at least 1200 mm and at most 3000 mm, and a thickness of 0.5 mm to 7.5 mm, the function unit having a grey wedge as sunshade and a polymer film as function interlayer having vibration-damping function.

16. The function roof of claim 15, wherein at least one of the following is satisfied:
the length is at least 3000 mm;
the width is at least 2400 mm; or
the thickness is up to 3.8 mm.

17. The function roof of claim 11, wherein the function roof is in the form of an aesthetic roof, wherein the function unit has light-emitting devices as the at least one function element and the outer protective pane has transmittance Y (D65, 2°) of at least 92.5% based on the outer protective pane having a thickness of 5 mm.

18. The function roof of claim 17, wherein the transmittance Y (D65, 2°) is at least 93%.

19. The function roof of claim 11, wherein the function roof is in the form of a switchable window, the function roof comprising a switchable film disposed between the outer protective pane and the inner pane as the at least one function element in the function unit, and a transparent conductive coating is applied on a side of the outer protective pane facing the switchable film, the outer protective pane having transmittance Y (D65, 2°) of at least 92.5% based on the outer protective pane having a thickness of 5 mm.

20. The function roof of claim 11, wherein the function roof is in the form of a solar roof, the function unit having, as the at least one function element, an electrical component that converts radiative energy directly to electrical energy, the outer protective pane having transmittance Y (D65, 2°) of at least 92.5% based on the outer protective pane having a thickness of 5 mm.
